(19) United States
(12) Patent Application Publication
(10) Pub. No.: US 2005/0200926 A1
(43) Pub. Date: Sep. 15, 2005

(54) Optical recording medium

(75) Inventors: Ikuo Aoki, Yokohama (JP); Yoshitaka Takahashi, Yokohama (JP)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd, Suwon-si (KR)

(21) Appl. No.: 11/064,119

(22) Filed: Feb. 17, 2005

(30) Foreign Application Priority Data
Mar. 9, 2004 (JP) 2004-65841
Oct. 5, 2004 (KR) 2004-79210

(51) Int. Cl. G02B 5/32

(52) U.S. Cl. 359/15; 359/3

(57) ABSTRACT

An optical recording medium for performing a hologram recording on a first layer and a ROM reproducing layer or a thermal recording layer and easily detecting the recording location of a hologram without reducing a recording capacity. The optical recording medium includes one surface having a hologram recording layer for recording information of an object beam as interference fringes by irradiating the object beam and a reference beam and at least one other surface having a ROM layer or a thermal layer on which pits are formed to store information to easily detect the recorded location of the hologram.

### CROSS-REFERENCE TO RELATED APPLICATIONS

This application claims the priority of Japanese Patent Application No. 2004-65841, filed on Mar. 9, 2004 in the Japanese Intellectual Property Office, and Korean Patent Application No. 2004-79210, filed on Oct. 5, 2004 in the Korean Intellectual Property Office, the disclosures of which are incorporated herein in their entirety by reference.

### BACKGROUND OF THE INVENTION

1. Field of the Invention

The present invention relates to a recording medium, and more particularly, to an optical recording medium having both a hologram recording layer on which data is recorded as interference fringes by using an object beam and a reference beam and a conventional optical recording layer.

2. Description of the Related Art

A rewritable optical disk of a phase shift type or an optical magnetic type is widely used as an information recording medium. In order to increase the recording density of such an optical disk, the diameter of a beam spot needs to be reduced and the distance between adjacent tracks or adjacent bits needs to be made smaller. Although the recording density of an optical disk has been increased, the recording density of an optical disk is physically limited by a diffraction limit of a beam for recording data on a recording surface of the optical disk. Accordingly, a three dimensional multi-recording including a depth direction is required to increase the recording density of an optical disk.

A hologram recording medium having a large capacity due to a three dimensional multi-recording region and that can be used at a high speed due to a two dimensional recording/reproducing method has attracted public attention as a next generation of computer recording media. Such a hologram recording medium may be formed by inserting a recording layer formed of a photopolymer, between two sheets of glass. In order to record data on the hologram recording medium, an object beam and a reference beam corresponding to data to be recorded are irradiated to the hologram recording medium to form interference fringes. In order to reproduce data from the hologram recording medium, a reference beam is irradiated to the interference fringes to extract optical data corresponding to the recorded data.

Since a plurality of two dimensional data are recorded in the same region, the hologram recording medium formed in the same shape as a compact disk has a huge recording density on the order of tera-bytes. On the other hand, this type of medium requires very precise control of an optical system when performing multi-recording thereon in order to accurately detect locations on the medium. Thus, Japanese Laid-open Patent No. 10-124872 discloses a technology related to arranging address information on a hologram recording medium. However, when using this technology, a region for recording location information (i.e., address data or information) and a data region are formed on the same surface so that it is impossible to perform a hologram multi-recording on a recording surface and a recording capacity is reduced.

### SUMMARY OF THE INVENTION

Aspects of the present invention provide an optical recording medium that allows hologram recording and data reproducing on and from a recording surface thereof, such that a recording location of a hologram can be conveniently detected without reducing a recording capacity.

Additional aspects and/or advantages of the invention will be set forth in part in the description which follows and, in part, will be obvious from the description, or may be learned by practice of the invention.

According to an aspect of the present invention, there is provided an optical recording medium including one surface having a hologram recording layer for recording information of an object beam as interference fringes by irradiating the object beam and a reference beam and other surface having a ROM layer in which concave or convex pits are formed.

In an aspect of the present invention, optional information is recorded as ROM information on the hologram recording medium without reducing a recording capacity thereof, and a location determination control may be performed precisely.

In an aspect of the present invention, the ROM layer has location information of the optical recording medium.

In an aspect of the present invention, the location information is preliminarily recorded as ROM information on the hologram recording medium without reducing the hologram recording capacity, and thus an access to a predetermined address can be performed precisely and promptly when performing hologram recording/reproducing.

In an aspect of the present invention, the surface having the ROM layer is formed of a ROM type optical disk.

In an aspect of the present invention, it is possible to record the optional information on the ROM layer, and the access to a predetermined address can be performed precisely and promptly by using the address information of the ROM type optical disk when performing the hologram recording/reproducing.

According to another aspect of the present invention, there is provided an optical recording medium including one surface having a hologram recording layer for recording information of an object beam as interference fringes by irradiating the object beam and a reference beam and other surface having a thermal recording layer.

In an aspect of the present invention, optional information is additionally recorded on a hologram recording medium without reducing a hologram recording capacity by performing a thermal recording.

In an aspect of the present invention, the thermal recording layer has concave or convex grooves.

In an aspect of the present invention, the location of an optical system is precisely determined by controlling the optical system to move along the concave or convex grooves.

In an aspect of the present invention the distance between the concave or convex grooves may be equal to a divisor of a hologram shift amount of a shift multi-recording in a perpendicular direction of the concave or convex grooves.

In an aspect of the present invention, since the distance between the concave or convex grooves is determined by the divisor of the hologram amount of the shift multi-recording, it is possible to control the shift amount over the total area of the optical recording medium when performing the hologram multi-recording by moving the optical system along the grooves.

In an aspect of the present invention, the thermal recording layer has location information of the optical recording medium.,

In an aspect of the present invention, the location information is recorded on the hologram recording medium without reducing a hologram recording capacity, thus an access to a predetermined address may be precisely and promptly controlled when performing hologram recording/reproducing.

In an aspect of the present invention, the surface having the thermal recording layer is formed of a recordable optical disk.

In an aspect of the present invention, optional information is recorded on the thermal recording layer, and the access to a predetermined address may be precisely and promptly performed when performing the hologram recording/reproducing by using address information of the recordable optical disk.

In an aspect of the present invention, the optical recording medium includes a total reflection layer interposed between the hologram recording layer and the ROM layer.

In an aspect of the present invention, it is possible to perform recording/reproducing without interference between a hologram recording layer signal and a ROM layer signal.

In an aspect of the present invention, the optical recording medium includes a total reflection layer interposed between the hologram recording layer and the thermal recording layer.

In an aspect of the present invention, it is possible to perform recording/reproducing without interference between a hologram recording layer signal and a thermal recording layer signal.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A and 1B area sectional view and a plane view, respectively, of an optical recording medium according to an embodiment of the present invention;

FIG. 2 is a sectional view of an optical recording medium according to another embodiment of the present invention;

FIGS. 3A and 3B are a sectional view and a plane view, respectively, of an optical recording medium according to another embodiment of the present invention; and

FIG. 4 is a block diagram of a recording and/or reproducing apparatus according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

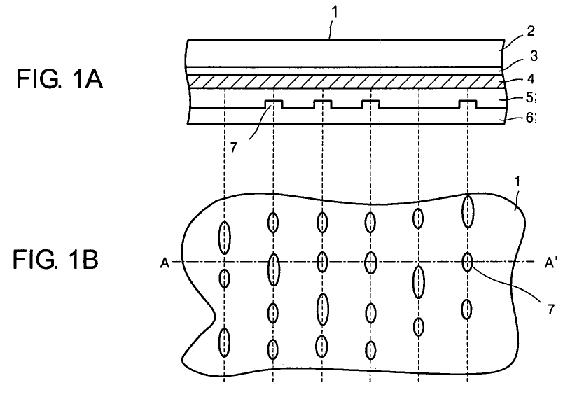

Referring to FIGS. 1A and 1B, an optical recording medium 1 according to an embodiment of the present invention includes a substrate 2, a hologram recording layer 3, a total reflection layer 4, a protective layer 5, a coat layer (not shown), an adherence layer (not shown), and a substrate 6 having pits 7. The sectional view shown in FIG. 1A of the optical recording medium 1 is taken along the line A-A′ of the plane view shown in FIG. 1B. The optical recording medium 1 includes both the hologram recording layer 3 and an optical recording layer comprised of the substrate 6 having the pits 7.

Location information of the optical recording medium 1 is recorded in the pits 7, and a location for recording a hologram or the location of a recorded hologram may be detected by optically reading with an optical pickup of a recording and/or reproducing apparatus the location information of the optical recording medium 1 from the substrate 6. The information recorded in a ROM unit of the optical recording layer includes optional information other than the location information according to an aspect of the present invention. For instance, the ROM unit could include copy protection data and/or user data.

The ROM unit may be formed of a ROM type optical disk, for example, a CD-ROM or a DVD-ROM. In this case, the location information for recording a hologram or the recorded hologram may be obtained from the address information of the CD-ROM or the DVD-ROM.

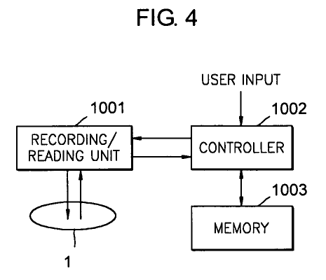

The holographic recording layer 3 uses photosensitive material, such as a photopolymer or photorefractive crystal, to record interference patterns caused by an object beam and a reference beam. The object beam includes data or other information. In order to reproduce data from the hologram recording medium, a reference beam is irradiated to the interference fringes to extract optical data corresponding to the recorded data. In addition, the total reflection layer 4 reflects the object beam and the reference beam, which are irradiated to the hologram recording layer 3 from a holographic recording and/or reproducing apparatus (not shown), and prevents the object beam and the reference beam from reaching the ROM unit and thus corrupting the data or information stored in the ROM unit. Accordingly, the hologram recording layer 3 and the ROM unit may be optically separated by the total reflection layer 4. Thus the object beam and the reference beam cannot interfere with a detection beam from, for example, an optical pickup such as that shown in FIG. 4, which detects location detection information arranged in a concave shape or a convex shape on the ROM unit. As a result, recording and reproducing data of high quality may be performed with the optical recording medium 1 when used with a recording and/or reproducing apparatus.

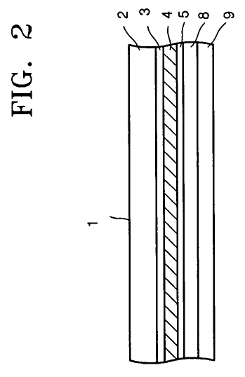

Referring to FIG. 2, an optical recording medium 1 according to another embodiment of the present invention includes a substrate 2, a hologram recording layer 3, a total reflection layer 4, a protective layer 5, a coat layer (not shown), an adherence layer (not shown), a thermal recording layer 8, and a substrate 9.

The location information of the optical recording medium 1 is recorded on the thermal recording layer 8 by a recording and/or reproducing apparatus illustrated in FIG. 4. Thus the location information is optically read by an optical pickup from the substrate 9 and the location for a recording hologram and the location of a recorded hologram are determined. The location information may be recorded in a hologram recording operation or may be preliminarily recorded. In addition, the thermally recorded information may include additional information other than the location information.

The total reflection layer 4 prevents an object beam and a reference beam from reaching the thermal recording layer 8. The object beam and reference beam record interference patterns in the hologram recording layer 3. The object beam includes data or other information, such that during reproduction of the data from the hologram recording medium, a reference beam is irradiated to the interference fringes to extract optical data corresponding to the recorded data. Accordingly, the hologram recording layer 3 and the thermal recording layer 8 may be completely separated by the total reflection layer 4, and thus the object beam and the reference beam cannot reach and interfere with or cause errors to an optical system, such as an optical pickup used to read the optical recording layer of the optical recording medium 1, when the location information from the thermal recording layer 8 is read or the location information is recorded on the thermal recording layer 8. As a result, recording and reproducing data of high quality may be performed using the optical recording medium 1.

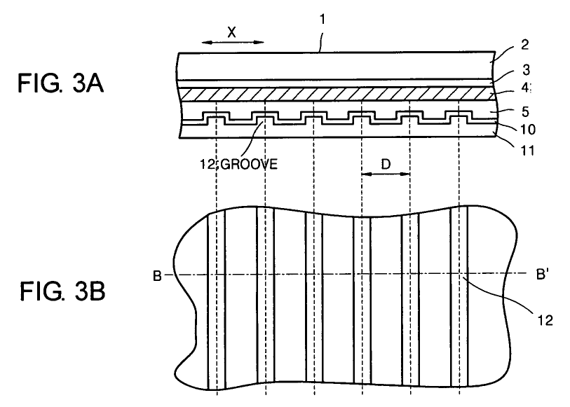

Referring to FIGS. 3A and 3B, an optical recording medium 1 according to another embodiment of the present invention includes a substrate 2, a hologram recording layer 3, a total reflection layer 4, a protective layer 5, a coat layer (not shown), an adherence layer (not shown), a thermal recording layer 10, a substrate 11 having concave or convex grooves 12. The sectional view shown in FIG. 3A of the optical recording medium 1 is taken along the line B-B′ of the plane view shown in FIG. 3B.

In this case, location information of the optical recording medium 1 is recorded on the thermal recording layer 10, and the location for recording a hologram or the location of a recorded hologram may be detected by optically reading the location information of the optical recording medium 1 from the substrate 11. The location information may be recorded in a hologram recording operation or may be preliminarily recorded. In addition, the thermally recorded information may include information other than the location information. It is understood that the recording and/or reproducing operations with respect to the thermal recording layer 10 may be performed by a recording and/or reproducing apparatus including an optical pickup such as that shown in FIG. 4. Also, wobble signals may be used to form the grooves.

The thermal recording layer may be formed of a recording optical disk, for example, CD-R/RW or DVD±R/W type of optical recording disks. In this case, the location for recording the hologram or the location of the recorded hologram may be obtained from address information of the CD-R/RW or DVD±R/W. It is understood that other types of optical disks may be used such as advanced optical disks (AOD) or Blu-ray discs.

The distance D of the grooves 12 is equal to a divisor of a shift amount when performing a shift multi-recording of a hologram in an X-direction. For example, when the shift amount is 12 μm, the distance D is 1, 2, 3, 4, 6, or 12 μm.

When the distance D is 12 μm, a detection optical system is controlled to move along the grooves, thus a recording and/or reproducing optical system is automatically moved by the shift amount in the X-direction. This situation refers to the case where the detection optical system of detecting the location information and the recording and/or reproducing optical system of the recording hologram are moved integrally or in a connected state. In addition, when the distance D is 3 μm, the recording and/or reproducing optical system is moved by the shift amount in the X-direction by skipping four grooves when moving the detection optical system.

While not specifically so limited, it is understood that the information storage medium 1 can include the CD-Rs, CD-RWs, DVD-RWs, DVD-RAMs, DVD+RWs, as well as next generation high definition DVDs, such as Blu-ray discs and Advanced Optical Discs (AODs).

FIG. 4 is a block diagram of a recording apparatus according to an embodiment of the present invention. Referring to FIG. 4, the recording apparatus includes a recording/reading unit 1001, a controller 1002, and a memory 1003. The recording/reading unit 1001 records data on an optical recording medium 1, which is an embodiment of the present invention, and reads the data from the optical recording medium 1. The controller 1002 records and reproduces optical recording medium related data according to the present invention as set forth above in relation to FIGS. 1 through 3B.

While not required in all aspects, it is understood that the controller 1002 can be a computer implementing the method using a computer program encoded on a computer readable medium. The computer can be implemented as a chip having firmware, or can be a general or special purpose computer programmable to perform the method.

In addition, it is understood that, in order to achieve a recording capacity of several dozen gigabytes on the optical recording layer, the recording/reading unit 1001 could include a low wavelength, high numerical aperture type unit usable to record dozens of gigabytes of data on the optical recording medium 1. Examples of such units include, but are not limited to, those units using light wavelengths of 405 nm and having numerical apertures of 0.85, those units compatible with Blu-ray discs, and/or those units compatible with Advanced Optical Discs (AOD). The recording/reading unit 1001 is also capable of producing the object and reference beams for creating and/or reading the interference fringes in the hologram layer.

Accordingly, a hologram recording and/or reproducing and a ROM recording and/or reproducing or a thermal recording and/or reproducing can be performed on a single optical recording medium, and the recording location of a hologram on a hologram recording layer can be easily detected.

Although a few embodiments of the present invention have been shown and described, it would be appreciated by those skilled in the art that changes may be made in this embodiment without departing from the principles and spirit of the invention, the scope of which is defined in the claims and their equivalents.

1. An optical recording medium for use with a recording and/or reproducing apparatus, the optical recording medium comprising:
a first surface of the optical recording medium having a hologram recording layer for recording information of an object beam as interference fringes by irradiating the object beam and a reference beam on the hologram recording layer; and
a second surface having a ROM layer on which pits are formed.

2. The optical recording medium of claim 1, wherein the ROM layer has location information on the optical recording medium corresponding to the hologram recording layer and/or the ROM layer.

3. The optical recording medium of claim 1, wherein the second surface having the ROM layer is formed of a ROM type optical disk.

4. The optical recording medium of claim 1, wherein the pits are concave and/or convex shaped.

5. The optical recording medium of claim 1, wherein a total reflection layer is interposed between the hologram recording layer and the ROM layer.

6. The optical recording medium of claim 1, further comprising:
a third surface disposed between the first surface and the second surface which reflects light.

7. An optical recording medium for use with a recording and/or reproducing apparatus, the optical recording medium, the optical recording medium comprising:
a first surface having a hologram recording layer for recording information on an object beam as interference fringes by irradiating the object beam and a reference beam; and a second surface having a thermal recording layer.

8. The optical recording medium. of claim 7, wherein the thermal recording layer has concave or convex grooves.

9. The optical recording medium of claim 8, wherein the distance between the concave or convex grooves is a divisor of a hologram shift amount of a shift multi-recording in a direction perpendicular to the concave or convex grooves.

10. The optical recording medium of claim 7, wherein the thermal recording layer has location information on the optical recording medium.

11. The optical recording medium of claim 7, wherein the surface having the thermal recording layer is formed of a recordable optical disk.

12. The optical recording medium of claim 7, further comprising a total reflection layer interposed between the hologram recording layer and the thermal recording layer.

13. An information storage medium for use with a recording and/or reproducing apparatus, the information storage medium comprising:
a first layer which comprises a hologram to store information; and
a second layer which comprises an optical recording layer which stores address information corresponding to the first layer for use by the recording and/or reproducing apparatus.

14. The information storage medium of claim 13, wherein the optical recording layer comprises a ROM layer.

15. The information storage medium of claim 13, wherein the optical recording layer comprises a thermal layer.

16. The information storage medium of claim 15, wherein the thermal layer includes concave or convex grooves spaced by a divisor of a shift multi-recording of the hologram in a perpendicular direction perpendicular to the concave or convex grooves.

17. The information storage medium of claim 13, further comprising a reflection layer disposed between the first and second layers.

18. The information storage medium of claim 13, wherein the second layer comprises data in addition to the address information.

19. A recording and/or reproducing apparatus to record and/or reproduce data with respect to an information storage medium having a first layer which comprises a hologram to store information and a second layer which comprises an optical recording layer which stores address information corresponding to the first layer for use by the recording and/or reproducing apparatus, the apparatus comprising:
an optical pickup to transfer data with respect to the information storage medium; and
a controller which controls the optical pickup to detect the first and second layers and which controls the optical pickup to transfer the address information with respect to the second layer of the information storage medium and to transfer the information with respect to the first layer according to the address information.

20. A method of transferring data with respect to a hologram layer of an information storage medium according to information stored on an optical recording layer of the information storage medium, comprising:
detecting from the information storage medium the information from the optical recording layer;
transferring the data between a recording and/or reproducing apparatus and the hologram layer of the information storage medium according to the information.

21. The method of claim 20, wherein the second information is address information corresponding to the data of the hologram layer.
